(19) United States
(12) Patent Application Publication
(10) Pub. No.: US 2020/0160461 A1
(43) Pub. Date: May 21, 2020

(54) ELECTRIC VEHICLE CHARGING NETWORKS

(71) Applicant: Alva Charge LLC, New York, NY (US)

(72) Inventor: Mbago Kaniki, New York, NY (US)

(21) Appl. No.: 16/280,858

(22) Filed: Feb. 20, 2019

Related U.S. Application Data
(60) Provisional application No. 62/769,863, filed on Nov. 20, 2018.

(51) Int. Cl. G06Q 50/06; H02J 3/38; H02J 7/00; G06Q 10/06; G06Q 20/20; G06Q 30/02

(52) U.S. Cl. CPC G06Q 50/06; H02J 3/381; H02J 7/0013; G05D 1/0212; G06Q 20/202; G06Q 30/0206; G06Q 30/0202; G06Q 10/06315

(57) ABSTRACT

The systems, methods, apparatus and computer products described herein offer a novel solution to the problem of providing high-power (i.e., 50 kW or greater) charging of electric vehicles. Such described approaches address the technical and economic challenges attendant with concurrent, high-power charging of multiple electric vehicles, including but not limited to, grid impact, demand charges and the need for grid upgrades. In one particular implementation, a swappable energy storage device is located at one or more electric vehicle charging stations, thus enabling the power and energy requirements for concurrent, high-power charging of multiple electric vehicles to be met without drawing electricity from the electric utility grid. More particularly, swappable energy storage may be charged at other sites with fewer grid constraints relative to the locations of electric vehicle charging stations. This mitigates grid impact and reduces the need for grid upgrades. Also, swappable energy storage may be charged at other sites with favorable power costs relative to the locations of electric vehicle charging stations. This reduces demand charges.

### CROSS REFERENCE TO RELATED APPLICATION

The present application claims priority to and the benefit of U.S. provisional patent application No. 62/769,863, filed Nov. 20, 2018, which is hereby incorporated by reference in its entirety.

### FIELD OF THE INVENTION

The present apparatus, systems and methods are directed to modular, rechargeable power systems for use with electric vehicles and other associated infrastructure.

### BACKGROUND OF THE INVENTION

Electric vehicles are becoming increasingly prevalent, due in part to a combination of market forces and regulatory requirements. Electric vehicles offer several benefits compared to internal combustion engine vehicles, including lower operating costs, lower greenhouse gas emissions and greater energy security. Electric vehicles have lower operating costs due to substantially less maintenance because of fewer mechanical parts to wear, and potentially cheaper fuel depending on the cost of electricity vs. petroleum-based fuels.

Electric vehicles can be part of a concerted effort to lower greenhouse gas emissions because the mix of inputs used to generate electricity is less polluting than petroleum-based fuels burned by internal combustion engine vehicles. This emissions advantage is especially pronounced in cases where electricity is generated using low-carbon inputs such as natural gas, or zero-carbon sources such as solar, wind, geothermal, hydro and wave. Electric vehicles support energy independence because electricity may be generated from a multitude of sources, whereas petroleum-based fuels are derived from one commodity (i.e., crude oil).

However, as the number of electric vehicles increases, so does the amount of electric power that the devices need to have available to support full charging levels. Broadly deployed power levels for charging light-duty electric vehicles (today, primarily passenger cars) presently consist of: AC Level 1 (up to 1.9 kW); AC Level 2 (up to 19.2 kW); DC Level 1 (up to 36 kW); DC Level 2 (up to 90 kW); and Tesla Supercharger (up to 120 kW). For more robust commercial, institutional and industrial applications, existing power levels for charging heavy-duty electric vehicles (today, primarily transit buses) principally encompass 25-150 kW for depot charging and 300-500 kW for on-route charging.

Thus, it would be beneficial to increase power levels available for electric vehicle charging in order to support faster charging and/or charging of larger vehicles. Currently, there are initiatives to build out light-duty electric vehicle charging stations with power up to 350 kW. Additionally, industry participants anticipate heavy-duty electric vehicle charging stations with power in excess of 1 MW. For context, 1 MW is equivalent to the instantaneous electrical demand of 750 average American homes.

Increasing power levels for electric vehicle charging pose technical and economic challenges, including grid impact and demand charges. Grid impact refers to the strain on the electric utility grid, which may create reliability problems (e.g., brownouts and blackouts) or require capital upgrades (e.g., new feeders and substations). Besides operational issues, grid impact creates potentially lengthy delays in deploying electric vehicle charging infrastructure, with feeder and substation improvements taking up to 36-48 months to complete. Additionally, it is common for electric utilities to levy demand charges on their customers based on the customers' peak power requirements (separate from consumption charges based on the total amount of energy used). High-power charging can generate large demand charges, which can render electric vehicle charging infrastructure uneconomic. This is especially true if utilization is low and there is insufficient total charging volume over which to spread the demand charges.

Currently, electric vehicles are charged using stations that are deployed primarily in residential or commercial parking structures (e.g., garages, depots and parking lots), and less commonly in dedicated refueling locations (e.g., electric vehicle charging plazas and petroleum-based fuel stations). Existing electric vehicle charging stations are predominantly built into the host site structure and occasionally built into carts located on the host site premises. Most existing electric vehicle charging stations simultaneously draw electricity from the electric utility grid and transfer it to electric vehicles.

Thus, what is needed in the art is an approach that allows for rapid charging of both light-duty and heavy-duty electric vehicles without putting undue strain on the electric utility grid. Furthermore, what is needed are systems, methods and apparatus that allow for concurrent, high-power charging of multiple electric vehicles to be conducted in the most resource efficient or advantageous manner, while also limiting the direct impact that such charging may have on the electric utility grid.

### SUMMARY OF THE INVENTION

The systems, methods, apparatus and computer products described herein offer a novel solution to the problem of providing high-power (i.e., 50 kW or greater) charging of electric vehicles. Such described approaches address the technical and economic challenges attendant with concurrent, high-power charging of multiple electric vehicles, including but not limited to, grid impact, demand charges and the need for grid upgrades. In one particular implementation, a swappable energy storage device is located at one or more electric vehicle charging stations, thus enabling the power and energy requirements for concurrent, high-power charging of multiple electric vehicles to be met without drawing electricity from the electric utility grid. More particularly, swappable energy storage may be charged at other sites with fewer grid constraints relative to the locations of electric vehicle charging stations. This mitigates grid impact and reduces the need for grid upgrades. Also, swappable energy storage may be charged at other sites with favorable power costs relative to the locations of electric vehicle charging stations. This reduces demand charges. Collectively, these attributes of swappable energy storage improve the feasibility of high-power charging for electric vehicles. The systems, methods, apparatus and computer products described herein include electric vehicle charging stations, energy storage devices, energy storage charging facilities, energy transport vehicles and control software that, when used collectively, allow for and/or enable concurrent, high-power charging of multiple electric vehicles with lower grid impact over conventional approaches.

By way of non-limiting example, the systems, apparatus, methods and computer products described herein are directed to power management configurations that include the use of an energy storage device configured to store energy, where the energy storage device is configured to receive energy and configured to discharge energy. The described approaches also include one or more power management devices that are configured to selectively receive or route energy from one of a plurality of energy sources and/or the energy storage device. The routed energy is directed to a load based on a determination made by one or more computers or processors. For example, a processor, suitably configured by one or more modules executing as code, receives from one or more energy metering sources a cost for energy available from one of a plurality of energy sources and determines the cost of the energy stored in the energy storage device. The processor is then further configured to cause the power management device to select either one of the many energy sources or the energy storage device to deliver energy to a load such as the battery of an electric vehicle.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional features and advantages will be made apparent from the following Detailed Description that proceeds with reference to the accompanying Drawings.

### DESCRIPTION OF THE DRAWINGS

The foregoing and other features of the present invention will be more readily apparent from the following Detailed Description, which may be best understood when taken in conjunction with the accompanying Drawings, in which:

FIG. 1 is a block diagram of an exemplary electric vehicle charging station with an exemplary microgrid.

FIG. 2 is a perspective view of exemplary swappable energy storage equipment depicted in FIG. 1.

FIG. 3 is a block diagram of an exemplary energy storage charging facility with an exemplary microgrid.

FIG. 4 is a block diagram of an exemplary control module for an exemplary electric vehicle charging network containing exemplary electric vehicle charging stations depicted in FIG. 1 and exemplary energy storage charging facilities depicted in FIG. 3.

FIG. 5 is a block diagram detailing particular features of an exemplary implementation of an exemplary electric vehicle charging network.

FIGS. 6A and 6B are a flow diagram of an exemplary method for operating exemplary control software depicted in FIG. 4.

FIG. 7 is a diagram of an exemplary control system according to a particular implementation of subject matter described herein.

FIG. 8 is a flow diagram of an exemplary method for operating exemplary control software depicted in FIG. 4.

### DETAILED DESCRIPTION OF THE INVENTION

By way of introduction, the presently described systems, methods, apparatus and computer products are directed to unique, novel and non-routine approaches for allowing high-power (i.e., 50 kW or greater) charging of electric vehicles while also minimizing grid impact. For example, the described systems, methods, apparatus and computer products provide for customized energy sources that address the technical and economic challenges associated with concurrent, high-power charging of multiple electric vehicles. In one particular implementation, the presently described approaches minimize grid impact, demand charges and the need for grid upgrades. The systems, methods, apparatus and computer products described herein include electric vehicle charging stations, energy storage devices, energy storage charging facilities, energy transport vehicles and control software.

The systems, methods, apparatus and computer products described herein refer to specific devices or structures, such as storage batteries, wheeled chassis, tractors and other like specific devices or structures. Such references, however, are strictly exemplary and are made for ease of description and presentation and are not intended to limit the mechanisms described to the specific environments and devices enumerated. In particular, to the extent that alternative devices or structures accomplish the intended and described results and do so within the confines of the systems described, such alternative devices and structures are equivalents to those described and are meant to be encompassed by the descriptions herein.

In more particular overview, the present disclosure describes the elements and aspects of one or more implementations of the invention described with respect to electric vehicles. The term “vehicles,” as used herein, should be understood to be generic and not indicative of any particular class of conveyances. Furthermore, as used herein, the term “vehicle” can cover conveyances that travel over land, underground, in the air, on water or submerged in water. For example, the term “vehicle” as used throughout shall encompass electrically powered or power assisted scooters, bicycles, motorcycles, cars, trucks, trains, boats, submarines, drones, aircraft, dirigibles, tracked vehicles and other conveyances.

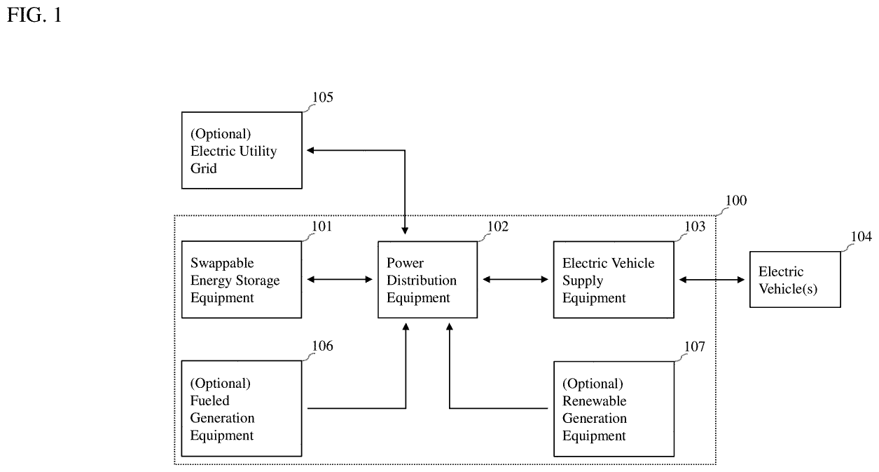

Turning to FIG. 1, in a particular implementation a charging station 100 is described. In the particular implementation depicted in FIG. 1, the charging station is an electric vehicle charging station that is configured as an exemplary microgrid. That is, the particular elements shown and/or described are configured to work together or otherwise cooperate to provide an energy source as well as the necessary elements needed to route energy from the energy source to one or more intended destinations.

With continued reference to FIG. 1, the energy storage equipment provides a source of electricity to the electric vehicle charging station 100. In one particular configuration, the energy storage equipment is swappable, such that it can be removed or replaced. This electricity from the swappable energy storage equipment 101 is directed to the power distribution equipment 102. The power distribution equipment 102 is equipped with one or more processors or computers configured by code executing therein to channel electricity from one or more sources to one or more destinations. In a particular configuration, such channeling is supported by one or more transformers, switches, coupling or other hardware and software necessary to effectuate energy distribution between an energy source and an energy destination.

In a particular implementation, the power distribution equipment 102 is also communicatively coupled to the swappable energy storage equipment 101 so that it can deliver energy to the swappable energy storage equipment 101. When electricity is delivered from the swappable energy storage equipment 101 to the power distribution equipment 102, it can in turn be routed to one or more output destinations such as the electric vehicle supply equipment 103, which in turn sends it to an electric vehicle 104. The electricity from the swappable energy storage equipment 101 is directed to the power distribution equipment 102 under the control of a processor or computer that is configured to evaluate one or more environmental or operational parameters relevant to energy demand and availability. In a further implementation, electricity from an optional electric utility grid 105, fueled generation equipment 106 and/or renewable generation equipment (i.e., solar, wind, geothermal, hydro, wave, etc.) 107 is also directed to the power distribution equipment 102 and in turn routed to the one or more output destinations. Here, such direction is carried out by one or more hardware and/or software components that are pre-configured or dynamically adjustable so as to allocate the desired energy to the intended energy recipient.

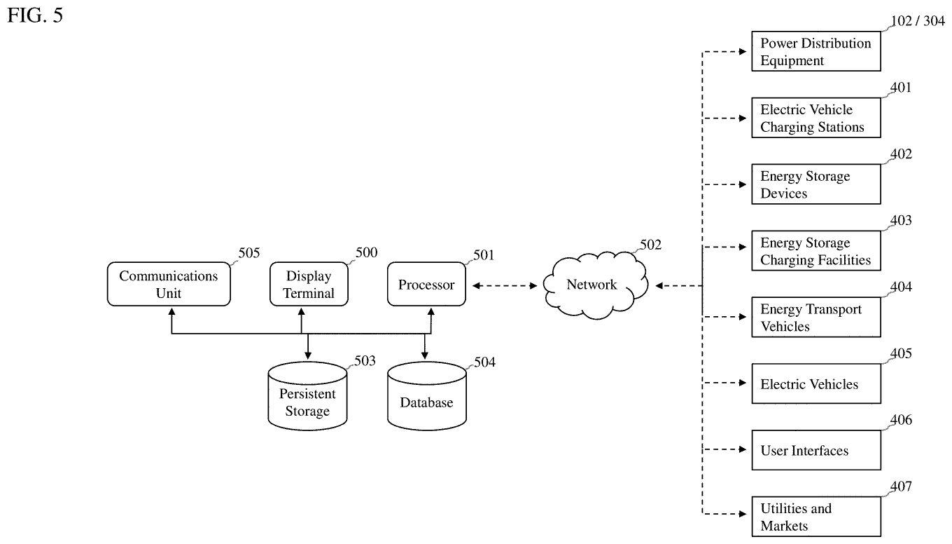

The electric vehicle supply equipment 103 can transfer electricity to electric vehicles 104 via cable (not shown), pantograph (not shown) or wireless (not shown) connection. In one further implementation, the electric vehicle supply equipment 103 may contain a user interface (not shown) and point-of-sale software (not shown), provided on a local or remote user display terminal (shown as element 500 of FIG. 5).

In one or more configurations, the electric vehicle charging station 100 may optionally draw electricity from an electric utility grid 105, fueled generation equipment 106 and/or renewable generation equipment 107 based on one or more indicia or criteria, such as availability or cost of energy produced by one or more of the energy sources 105, 106 and 107. In one or more configurations, electricity from an optional electric utility grid 105, fueled generation equipment 106 and/or renewable generation equipment 107 is channeled by the power distribution equipment 102 to one or more of the swappable energy storage equipment 101 and the electric vehicle supply equipment 103.

It will be appreciated that, with respect to the fueled generation equipment 106, such devices include, but are not limited to, reciprocating engines, gas turbines, steam turbines, microturbines or fuel cells. Input fuel (not shown) for fueled generation equipment 106 may include diesel, natural gas, biogas, liquified petroleum gas, sour gas, industrial waste gas, manufactured gas, synthetic gas, landfill gas, fuel oils, hydrogen, propane or methanol. However, those skilled in the art will appreciate that other commonly understood means of generating electricity from the consumption of fuel are also anticipated and incorporated herein.

The electric vehicle charging station 100 may additionally draw electricity from electric vehicles 104 via cable (not shown), pantograph (not shown) or wireless (not shown) connection. In this case, electricity from electric vehicles 104 is channeled through the electric vehicle supply equipment 103 and the power distribution equipment 102, either to the swappable energy storage equipment 101 or to an optional electric utility grid 105. Here, one or more hardware and/or software components are configured to route the energy to the intended destination based on data feeds, sensor inputs, monitor values or other information sources.

It will be appreciated that the charging apparatus depicted in FIG. 1 is suitable for use as a standalone charging station for any electrical device. While electric vehicles 104 are used for ease of explanation, other devices that utilize electrical energy can be charged using the configuration provided.

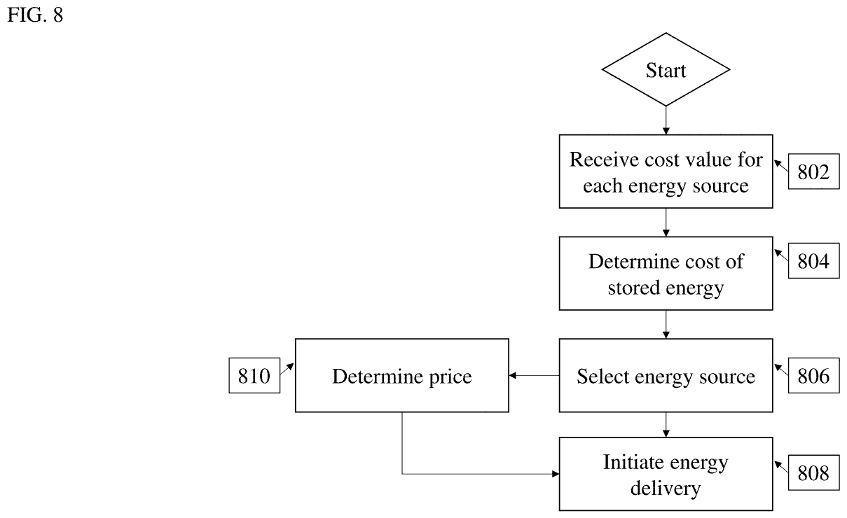

In one or more particular implementations, as indicated above the power distribution equipment 102 is controlled by one or more processors that are configured to execute code, access sensors or monitors, and issue instructions to the swappable energy storage equipment 101, the electric vehicle supply equipment 103, the fueled generation equipment 106, and the renewable generation equipment 107. For example, a processor or computer controlling the power distribution equipment 102 is configured by one or more modules to access data and control the functionality of the power distribution equipment 102 based on the evaluation and processing of such data. As shown in FIG. 8, such software can be described as a series of steps in a process carried out by a processor of the power distribution equipment 102. For instance, a processor of the power distribution equipment 102 is configured by a cost module to access or receive data relating to the present cost of energy provided by the electric utility grid 105, the fueled generation equipment 106 and/or the renewable generation equipment 107. As shown in step 802, a processor that controls or instructs the power distribution equipment 102 is configured to access one or more cost databases or real-time cost data feeds. From these data sources, one or more values representing the cost of various energy sources are extracted or received that represent the monetary cost of electricity sources available to the power distribution equipment 102. For instance, a local electric utility provides one or more metering tools or technologies accessible by a processor. These tools allow a processor to receive or determine the current cost for energy from the electric utility grid 105.

A processor is further configured, as in step 804, to determine the cost of the energy stored in the swappable energy storage equipment 101. In one implementation, a processor is configured to access historical energy usage data relating to the swappable energy storage equipment 101. For instance, in circumstances where the power distribution equipment 102 is configured to route energy to charge the energy storage equipment (such as swappable energy storage equipment 101), a processor monitors and stores the cost of the energy used to charge the swappable energy storage equipment 101. In further implementations, the cost value can be an average of several different charging events. In a further arrangement, the cost value is represented as a cost per a predetermined unit of energy stored by the swappable energy storage equipment 101 (e.g., cost per watt-hour). Using this information, a processor is configured by a storage cost module to access the storage cost value.

In a further implementation, a processor of the power distribution equipment 102 is configured by a selection module to determine an energy source to deliver energy to the electric vehicle 104 or other electrical device configured to receive energy from the charging station 100. As shown in step 806, the selection module configures a processor to select an energy source based on the received cost data. In one arrangement, one or more sub-modules of the selection module configure a processor of the power distribution equipment 102 to select the lowest cost energy source. For example, a processor of the power distribution equipment 102 is configured to compare the storage cost value determined or accessed in step 804 with the energy source cost values obtained in step 802 and to determine the lowest cost. Once the lowest cost source is selected, the energy is routed to the electric vehicle 104 or other device, as shown in step 808. For instance, a processor of the power distribution equipment 102 is configured by a routing module to route energy from the selected energy source to the intended destination load (e.g., the electric vehicle supply equipment 103 or directly to an electrical device in need of energy).

In yet a further configuration, the steps 802 and 806 are used to determine an energy source (i.e., sources 105, 106 and/or 107) to provide energy to the swappable energy storage equipment 101 so as to recharge the swappable energy storage equipment 101. Here, a processor is configured to use the cost values for the energy sources to determine the lowest cost energy source. Energy originating from the lowest cost energy source is routed by the power distribution equipment 102 to the swappable energy storage equipment 101.

In a further configuration, a processor is configured to determine a price for the energy delivered. Here, the processor determines the cost value of energy provided by the electric utility grid and the cost of one or more other energy sources. Where the cost of the energy from the electric utility grid exceeds the cost of the at least one of the other available energy sources, the processor is configured by a pricing module to price energy to a consumer at a value that is greater than the cost of the at least one of the other available energy sources that has a cost lower than the electric utility grid and the cost of the electric utility grid itself, as shown in step 810. As an alternative, rather than charging the swappable energy storage equipment 101, the power distribution equipment 102 may also determine the cost of energy from the fueled generation equipment 106 (e.g., based on the fuel cost) and/or the renewable generation equipment 107. Then the power distribution equipment 102 can supply energy to the electric vehicle supply equipment 103 from the lowest cost source (swappable energy storage equipment 101, electric utility grid 105, fueled generation equipment 106 or renewable generation equipment 107), assuming it is capable of supplying such energy.

In yet a further configuration, a processor is configured to determine a total energy demand from the user desiring to charge a device using the charging apparatus 100. For example, one or more software modules configure the processor to determine the capacity level of each of the plurality of energy sources. The processor is further configured to predict, using one or more predictive algorithms, that the total energy demand from the user will change the cost of each of the plurality of energy sources based, at least, upon the capacity level of each of the plurality of energy sources. Such predictive algorithms can include support vector or other types of regression analysis, machine learning algorithms, deep or recursive neural networks, or other algorithms configured to provide predictive values regarding the likelihood or probability of a future state. By way of non-limiting example, the processor is configured to extrapolate an energy demand trend based on one or more factors monitored by the processor. For example, historical data, current demand levels, weather or environmental conditions and the like can be used to calculate the likelihood of a demand change. In a further implementation, the processor (such as a processor of the power distribution equipment 102) is configured to determine the energy source that provides the lowest predicted energy cost for the total demand and cause the power distribution equipment 102 to deliver the energy from the energy source that provides the lowest predicted energy cost to the load (such as an electric vehicle 104 or another electrical device 104).

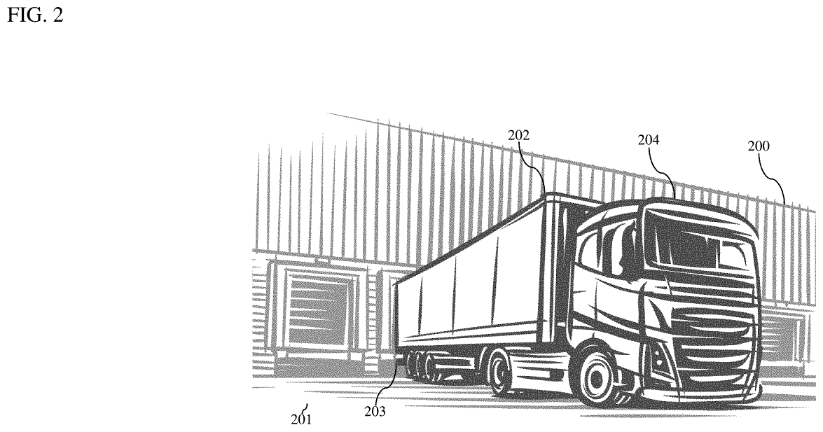

Turning now to FIG. 2, the swappable energy storage equipment 101 is depicted configured as one or more physical structures. In one implementation, the swappable energy storage equipment 101 is configured or secured within an enclosure or structure that provides protection from the elements or environmental conditions. In one implementation, the swappable energy storage equipment 101 includes a structure that has a closed or open roof.

In a particular configuration provided in FIG. 2, the swappable energy storage equipment 101 consists of an energy dock 200, an energy bay 201 and one or more energy storage devices 202. In the illustrated implementation, the relative size of each of the elements is shown for demonstration purposes. In alternative implementations, the size of the elements recited can be larger or smaller so long as such dimensions do not interfere with the functionality described herein.

In one particular implementation as provided in FIG. 2, the energy storage device 202 is mounted on a wheeled chassis 203 which is pulled or pushed by a tractor 204 to or from the energy dock 200. The energy storage device 202 may utilize lithium-ion, solid-state, metal-air, flow, fuel cell, capacitor or other energy storage technologies. It should be appreciated that while FIG. 2 refers to a tractor 204, the foregoing disclosure contemplates any means of conveyance of the energy storage device 202. In one implementation, the tractor 204 is operated either locally or remotely by a human driver. In an alternative implementation, the tractor 204 or a similar conveyance may operate autonomously.

In one configuration provided, the energy storage device 202 of FIG. 2 is introduced into the energy bay 201, where the energy bay 201 is equipped with one or more lifts, armatures or movement devices that allow for the energy storage device 202 to be positioned to couple with the energy dock 200. For example, the energy bay 201 includes one or more movement devices that move the energy storage device 202 in an X direction and a Y direction. In a further implementation, the movement devices are controlled or operated by one or more processors configured to execute instructions in response to one or more signals generated by one or more sensors. For example, the one or more movement devices are configured with object recognition optical cameras or scanners configured to identify a particular energy storage device 202, energy bay 201, energy dock 200 or other element. As used herein, the X direction is the direction of travel of the wheeled chassis 203 as it enters the energy bay 201. The Y direction is perpendicular to the X direction in a horizontal plane.

In the illustrated configuration, once the energy storage device 202 is in position relative to one or more connections available within the energy bay 201, it can transfer electricity to (discharging) or from (charging) the energy dock 200. In a particular implementation, the transfer of energy is determined based on one or more control signals or data input received by one or more processors. For instance, electricity is transferred between the energy storage device 202 and the energy dock 200 via cable (not shown), pantograph (not shown) or wireless (not shown) connection in response to a charging signal. For example, based on one or more operational conditions, a suitably configured processor causes the energy storage device 202 to either receive electrical energy or discharge electrical energy. For discharging, electricity from the energy storage device 202 is directed through the energy dock 200 of the swappable energy storage equipment 101 to the power distribution equipment 102. For charging, electricity is directed from the power distribution equipment 102 through the energy dock 200 of the swappable energy storage equipment 101 to the energy storage device 202.

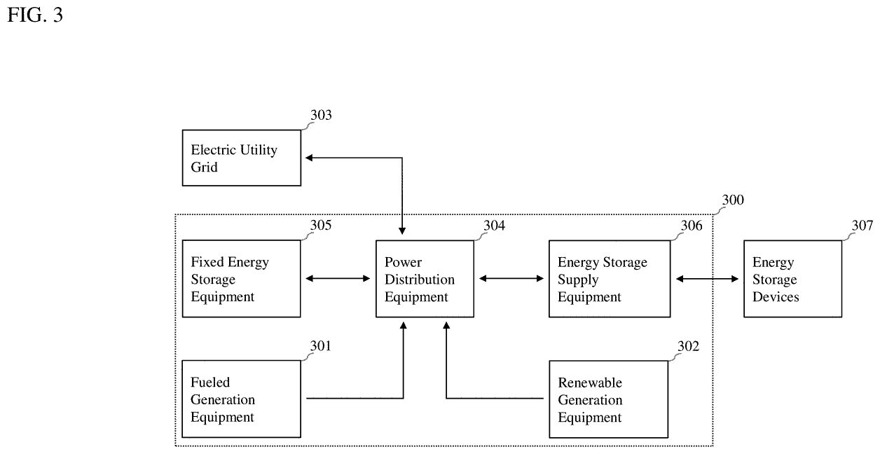

Turning to FIG. 3, a block diagram is provided of an exemplary energy storage charging facility 300 consisting of an exemplary microgrid, where the microgrid includes fixed energy storage equipment, power distribution equipment and energy storage supply equipment. For example, fixed energy storage equipment 305, power distribution equipment 304 and energy storage supply equipment 306 are co-located with one another such that they can be secured within a single structure or housing. In a further configuration, each of the fixed energy storage equipment 305, power distribution equipment 304 and energy storage supply equipment 306 are configured to exchange data with one another and/or with one or more control devices using wired or wireless data connections.

As provided herein, the energy storage charging facility 300 may draw electricity from the fueled generation equipment 301, the renewable generation equipment (i.e., solar, wind, geothermal, hydro, wave, etc.) 302 and/or the electric utility grid 303. In each case, electricity from the one or more energy sources (301, 302 and/or 303) is channeled by the power distribution equipment 304, either to the fixed energy storage equipment 305 or to the energy storage supply equipment 306. In one particular configuration, a processor of the power distribution equipment 304 determines which energy source to select and to which destination to route the energy based on one or more extrinsic or predetermined circumstances. For instance, where a processor of the power distribution equipment 304 includes one or more software modules configured for execution therein, the software modules are configured to access data relating to the availability, cost and user conditions associated with operational conditions of the overall system described. For example, using one or more controllable or selectable conduits, one or more processors are configured to initiate a transfer of electricity from the energy storage supply equipment 306 to the energy storage devices 307. For instance, in response to one or more flags, codes or signals given by one or more processors, electricity is transmitted to the energy storage devices 307 via cable (not shown), pantograph (not shown) or wireless (not shown) connection. For example, such a transfer can be initiated by a local or remote user display terminal (as shown in element 500 of FIG. 5) that provides one or more instructions that control the functionality of the power distribution equipment 304, the energy storage supply equipment 306 or the energy storage devices 307.

Returning to FIG. 3, in one implementation, the fueled generation equipment 301 may include, but is not limited to, reciprocating engines, gas turbines, steam turbines, microturbines or fuel cells. Input fuel (not shown) for the fueled generation equipment 301 may include diesel, natural gas, biogas, liquified petroleum gas, sour gas, industrial waste gas, manufactured gas, synthetic gas, landfill gas, fuel oils, hydrogen, propane or methanol. However, those skilled in the art will appreciate that other commonly understood means of generating electricity from the consumption of fuel are also anticipated and incorporated herein.

In a particular configuration described herein, the energy storage charging facility 300 may also draw electricity from the fixed energy storage equipment 305. For instance, a processor integral or otherwise configured to control the operation of the energy storage charging facility 300 is configured by one or more software modules to access data relating to the availability, price and user conditions associated with operational conditions of the overall system described with respect to the energy available from the fixed energy storage equipment 305. For instance, one or more software modules configure the processor to evaluate the energy cost associated with drawing electricity from the fixed energy storage equipment 305 and determine, based on extrinsic factors, whether to obtain energy from the fixed energy storage equipment 305 or another energy source. Based on the energy source selected by the processor, electricity from the fixed energy storage equipment 305 is channeled by the power distribution equipment 304, either to the energy storage supply equipment 306 or to the electric utility grid 303.

In an alternative operational mode or configuration, the energy storage charging facility 300 may draw electricity from energy storage devices 307 in response to one or more extrinsic or determined operational conditions or parameters. For instance, where the fixed energy storage equipment 305 is in need of additional charging capacity, one or more processors are configured to direct electricity via control hardware devices (e.g., cable (not shown), pantograph (not shown) or wireless (not shown) connection) from energy storage devices 307 through the energy storage supply equipment 306 and the power distribution equipment 304, either to the fixed energy storage equipment 305 or to the electric utility grid 303.

By way of particular example, the system of FIG. 3 can be implemented as one or more computer implemented methods. For example, a computer or processor is configured to receive, for a plurality of energy demand locations, energy demand data, wherein the energy demand data includes at least an energy demand value, a location value, and an energy demand price value. A suitably configured processor may compare the energy demand value to a predetermined demand threshold and the energy demand price value to a predetermined price threshold. In response to these comparisons, a processor or computer (such as processor 501 in FIG. 5) is configured to cause one of a plurality of energy transport devices, each of the plurality of energy transport devices configured to transport at least one energy storage device, to travel to at least one energy demand location where the energy demand value is above a predetermined demand threshold and the energy demand price value is above a predetermined price threshold.

In a further implementation, the computer implemented method may include a processor (such as processor 501 in FIG. 5) configured to receive, for a plurality of energy production facilities, energy production data, where the energy production data includes, for each one of the respective plurality of energy production facilities, an energy production capacity value, an energy production cost value, and the availability of at least one of a plurality of energy transport devices at the energy production facility. The processor is also configured, in one implementation, to compare the cost of the energy stored in each of the energy storage devices transported by at least one of the plurality of available energy transport devices and calculate an energy transport cost value that represents the cost of transporting the energy storage device to the energy demand location. Using this information, the processor is further configured to determine an effective energy cost value of the energy stored in each of the energy storage devices based on at least the energy production cost value and the energy transport cost value. In a particular implementation, one or more computers are used to calculate an energy demand price threshold value based on each of the effective energy cost values of each of the energy storage devices and identify at least one of the plurality of available energy transport devices that is transporting at least one energy storage device containing energy that has an effective energy cost value less than or equal to the energy demand price threshold value.

In accordance with one or more aspects of the described approach, the suitably configured computer or processor (such as processor 501 in FIG. 5) determines the present energy level of at least one of the energy storage devices (such as the percentage of remaining battery life) transported by at least one of the plurality of energy transport devices and identifies, from the energy demand data, one of the plurality of energy demand locations that have an energy demand value below a demand threshold, and are within a distance threshold of the one of the plurality of energy transport devices. Using this information, the computer instructs the one of the plurality of energy transport devices to travel to the identified energy demand location.

It will be appreciated, as described herein, that in one or more of the above described implementations, the energy transport device is an autonomous vehicle configured to communicate with at least one remote computer providing destination data. In a further implementation, each of the energy transport devices, autonomous or not, is equipped with one or more means or mechanisms for identifying a present location. For example, each electric conveyance or vehicle includes a location module, such as a global positioning system (GPS) module that enables the determination of the vehicle location using one or more satellite triangulation methods. In an alternative configuration, the location module includes hardware and software to determine the location of the user computing device using Internet Protocol (IP) addresses, radio telemetry, Wi-Fi, WiMAX, GSM, LTE and cellular or mobile network environment data. By way of further detail, the location module provides raw location data and/or location resolution or conversion data to the processor (such as processor 501 in FIG. 5). In one arrangement, the location module provides data to the processor 501 such that the location of the user computing device is determined or resolved to a mailing address, Cartesian coordinates (e.g., longitude and latitude) or landmark data.

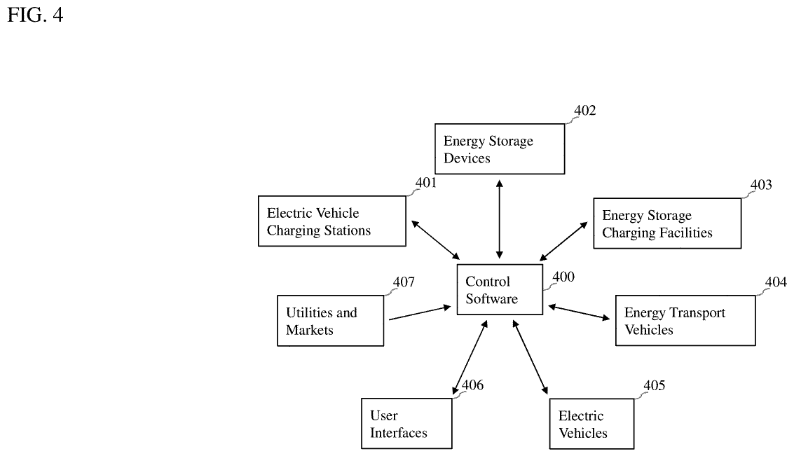

Turning to FIG. 4, a block diagram is provided of an exemplary control module for an exemplary electric vehicle charging network containing exemplary electric vehicle charging stations 100 depicted in FIG. 1 and exemplary energy storage charging facilities 300 depicted in FIG. 3. It should be understood that such a network may include one or more electric vehicle charging stations 401 and one or more energy storage charging facilities 403. Depleted energy storage devices 402 are transported from the electric vehicle charging stations 401 to the energy storage charging facilities 403. At the energy storage charging facilities 403, electricity is transferred to the depleted energy storage devices 402. Replenished energy storage devices 402 are then transported from the energy storage charging facilities 403 to the electric vehicle charging stations 401. In one or more configurations, the described and illustrated energy storage charging facilities 403 are located at sites where there are fewer grid constraints relative to the locations of electric vehicle charging stations 401. Such locations can be selected to mitigate grid impact and reduce the need for grid upgrades. Furthermore, the energy storage charging facilities 403 may be located at sites with favorable power costs relative to the locations of electric vehicle charging stations 401. In one operative mode, the processor is configured to optimize the reduction of present demand charges associated with accessing power directly from the electric utility grid.

In one configuration, energy storage devices 402 are moved between the electric vehicle charging stations 401 and the energy storage charging facilities 403 by the energy transport vehicles 404. The energy transport vehicles 404 may travel over land, underground, in the air, on water or submerged in water. The energy transport vehicles 404 may have human (local or remote) drivers, or they may operate autonomously.

In one particular implementation, control software 400 receives data from and transmits data to electric vehicle charging stations 401, energy storage devices 402, energy storage charging facilities 403, energy transport vehicles 404, electric vehicles 405 and user interfaces 406, either each independently or collectively. In one or more arrangements of software modules that configure the operation of one or more processors, the control software 400 receives data from energy utilities, commodity suppliers, financial markets 407 and other real-time, near real-time and historical data sets and sources.

As shown in FIG. 5, in one or more implementations, control software 400 configures one or more processors 501 to communicate with power distribution equipment 102/304, electric vehicle charging stations 401, energy storage devices 402, energy storage charging facilities 403, energy transport vehicles 404, electric vehicles 405, user interfaces 406 and utilities and markets 407 over wired or wireless networks.

The control software 400 may reside on cloud 502 or physical servers, that are a collection of processors 501. By way of explanation, the processor described herein refers to one or more computing devices, such as a commercially available microprocessor, processing cluster, integrated circuit, computer-on-chip or other data processing device. In one or more configurations, the processor is one or more components of a cellphone, smartphone, notebook or desktop computer configured to directly, or through a communication linkage, receive data related to the status of the components or elements described therein, including through one or more direct or remote connections to various energy management, current flow, charge rates, battery levels, switches and other power distribution elements. The processor is configured with code executing therein to access various peripheral devices and network interfaces. For instance, the processor is configured to communicate over the Internet with one or more remote servers, computers, peripherals or other hardware using standard or custom communication protocols and settings (e.g., TCP/IP).

In one configuration, the processor is a portable computing device such as an Apple iPad/iPhone® or Android® device or other commercially available mobile electronic device executing a commercially available or custom operating system (e.g., Microsoft Windows, Apple OSX, UNIX or Linux based operating system implementations). In other embodiments, the processor is, or includes, custom or non-standard hardware, firmware or software configurations. For instance, the processor comprises one or more of a collection of micro-computing elements, computer-on-chip, home entertainment consoles, media players, set-top boxes, prototyping devices or “hobby” computing elements.

The processor can comprise a single processor, multiple discrete processors, a multi-core processor or other type of processor(s) known to those of skill in the art, depending on the particular embodiment.

In one or more embodiments, the processor is directly or indirectly connected to one or more memory storage devices (memories) to form a microcontroller structure. The memory is a persistent or non-persistent storage device that is operative to store the operating system in addition to one or more software modules. In accordance with one or more embodiments, the memory comprises one or more volatile and non-volatile memories, such as read-only memory (ROM), random access memory (RAM), electrically erasable programmable read-only memory (EEPROM), phase change memory (PCM), single in-line memory (SIMM), dual in-line memory (DIMM) or other memory types. Such memories can be fixed or removable, as is known to those of ordinary skill in the art, such as using removable media cards or modules. In one or more embodiments, the memory of the processor provides for the storage of application program and data files. One or more memories provide program code that the processor reads and executes upon receipt of a start, or initiation signal. The computer memories may also comprise secondary computer memory, such as magnetic or optical disk drives or flash memory, that provide long-term storage of data in a manner similar to the persistent memory device. In one or more embodiments, the memory of the processor provides for storage of application programs or modules and data files when needed.

As shown in FIG. 5, memory and persistent storage 503 are examples of computer-readable tangible storage devices. A storage device is any piece of hardware that can store information, such as data, program code in functional form and/or other suitable information on a temporary basis and/or permanent basis. In one or more embodiments, memory includes random access memory (RAM). RAM may be used to store data such as measurement data in accordance with the present invention. In general, memory can include any suitable volatile or non-volatile computer-readable storage device. Software and data are stored in persistent storage 503 for access and/or execution by processors 501.

In a particular embodiment, persistent storage includes a magnetic hard disk drive. Alternatively, or in addition to a magnetic hard disk drive, persistent storage can include a solid-state hard drive, a semiconductor storage device, read-only memory (ROM), erasable programmable read-only memory (EPROM), flash memory or any other computer-readable storage devices capable of storing program instructions or digital information.

The database 504 may be embodied as solid-state memory (e.g., ROM), hard disk drive systems, RAID, disk arrays, storage area networks (SAN), network attached storage (NAS) and/or any other suitable system for storing computer data. In addition, the database may comprise caches, including database caches and/or web caches. Programmatically, the database may comprise flat-file data store, a relational database, an object-oriented database, a hybrid relational-object database, a key-value data store such as Hadoop or MongoDB, in addition to other systems for the structure and retrieval of data that are well known to those of skill in the art.

The media used by persistent storage may also be removable. For example, a removable hard drive may be used for persistent storage. Other examples include optical and magnetic disks, thumb drives and smart cards that are inserted into a drive for transfer onto another computer-readable storage medium that is also part of persistent storage.

In a particular embodiment, a communications or network interface unit 505 provides for communications between one or more processors (i.e., processor 501) and other systems, sub-systems or devices. For instance, communications unit 505 may provide appropriate interfaces to the Internet, an intranet or other suitable data communications network to connect to one or more servers, resources, API hosts or computers. In these examples, communications unit 505 may include one or more network interface cards. Communications unit 505 may provide bi-directional data transfers using either or both wired and wireless communications links implementing standard or understood communications protocols and approaches.

In one or more implementations, the system described herein includes or incorporates a display device or display terminal 500 so as to provide a user interface for a user to interact with the hardware and software modules described and to receive data relating thereto. In one or more configurations, there is a single user interface provided on the display terminal 500 that controls operation of the overall system described. In an alternative configuration, each hardware component or element is configured with one or more direct user interfaces, or a networked user interface accessible via a local or remote terminal. For example, the display terminal incorporated into any of the elements described herein can comprise a screen, monitor, display, LED, LCD or OLED panel, augmented or virtual reality interface or an electronic ink-based display device.

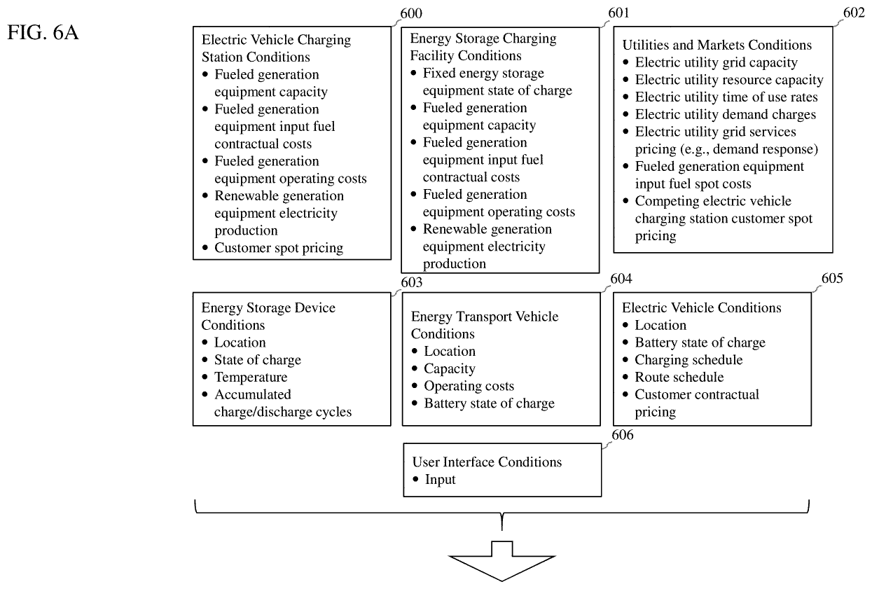

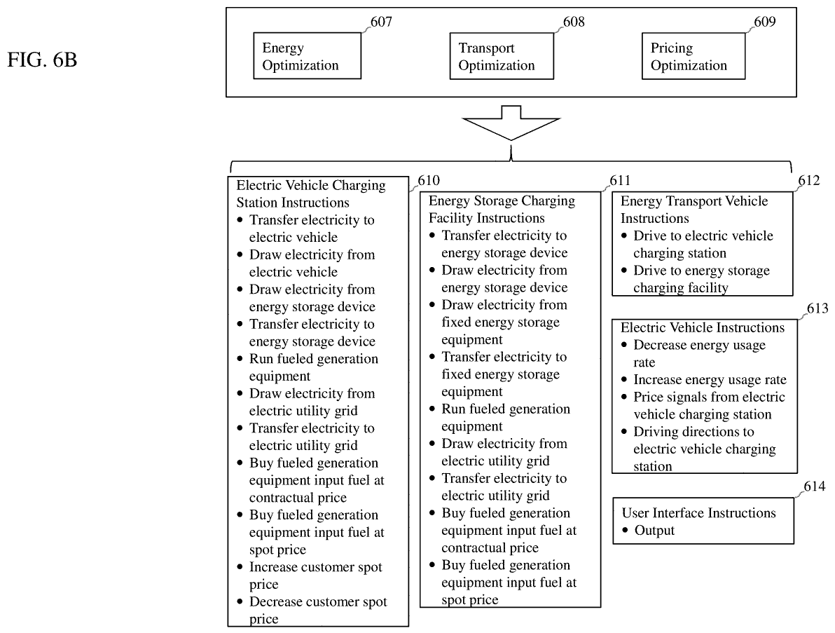

Onto FIGS. 6A and 6B, a flow diagram is provided detailing an exemplary method of operating control software 400, such as, but not limited to, the configuration depicted in FIG. 4. The control software 400 may utilize one or more decision trees, rules or machine learning algorithms (not shown) that configure one or more processors to evaluate data and control one or more hardware configurations in response thereto. The control software 400 as shown in FIG. 6A configures one or more processors to receive monitoring data for conditions related to electric vehicle charging stations 600, energy storage charging facilities 601, utilities and markets 602, energy storage devices 603, energy transport vehicles 604, electric vehicles 605 and user interfaces 606. Based on the monitoring data, the control software 400 in FIG. 6B configures the processor to perform one or more optimizations related to energy 607, transport 608 and pricing 609. Based on the optimizations 607, 608, 609 performed, the control software 400 configures the processor to provide instructions to electric vehicle charging stations 610, energy storage charging facilities 611, energy transport vehicles 612, electric vehicles 613 and user interfaces 614.

As an example, an electric vehicle charging station 401 is, in one implementation, a regional delivery truck charging terminal served by an energy storage charging facility 403. Monitoring of the electric vehicle charging station conditions 600 and energy storage device conditions 603 indicates the state of the charge for one or more energy storage devices 402. For instance, the control software 400 provides an indication that there exists a low state of charge for energy storage devices 402 at that location. Monitoring of electric vehicle conditions 605 could, in another implementation, show multiple regional delivery trucks traveling toward the electric vehicle charging station 401 and expected to reach it with a low state of charge after a pre-arrival window. Monitoring of electric vehicle conditions 605 could, in another implementation, further show that certain regional delivery trucks traveling toward the electric vehicle charging station 401 are fleet customers who would pay a contractual price while others are non-fleet customers who would pay a spot price. Monitoring of energy transport vehicle conditions 604 could, in another implementation, show that energy transport vehicles 404 have adequate capacity and state of charge to transport energy storage devices 402 from the electric vehicle charging station 401 to the energy storage charging facility 403 and back to the electric vehicle charging station 401 during the pre-arrival window.

Monitoring of energy storage charging facility conditions 601, in one implementation, shows that fixed energy storage equipment has a low state of charge and renewable generation equipment has low electricity production. Monitoring of energy storage charging facility conditions 601 could further show that fueled generation equipment has high available capacity and fueled generation equipment input fuel costs are high on a contractual basis. Monitoring of utilities and markets conditions 602 could, in another implementation, show that electric utility grid capacity is low, electric utility time of use rates are high and electric utility demand charges are high during the pre-arrival window. Monitoring of utilities and markets conditions 602 could also show that fueled generation equipment input fuel costs are low on a spot basis. Monitoring of utilities and markets conditions 602 could further show that competing electric vehicle charging stations have high rates for customers who would pay a spot price.

Based on the aforementioned monitoring data, one or more processors are configured to perform one or more optimizations related to energy 607, transport 608 and pricing 609. Based on the optimizations 607, 608, 609 performed, a series of instructions could be generated by the processor for transmission to one or more remote or local computer. For instance, energy transport vehicle instructions 612 are generated by the processor during the pre-arrival window. Such instructions could include instructions to control one or more control and/or navigation systems to: drive to the electric vehicle charging station; drive to the energy storage charging facility; and drive back to the electric vehicle charging station. In another configuration, energy storage charging facility instructions 611 generated by the processor during the pre-arrival window could include instructions to one or more control devices to: run the fueled generation equipment; buy fueled generation equipment input fuel on a spot basis; and transfer electricity to the energy storage devices. In a further configuration, electric vehicle charging station instructions 610 generated by the processor during the pre-arrival window could include: decrease customer spot prices. Likewise, electric vehicle instructions 613 generated by the processor during the pre-arrival window could include: notification of spot prices; and driving directions to the electric vehicle charging station. In a further non-limiting implementation, electric vehicle charging station instructions 610 generated by the processor during the post-arrival window could include: draw electricity from the energy storage devices; and transfer electricity to the electric vehicles.

By way of particular implementation, the electric vehicle charging network provided in FIG. 5 can be controlled by one or more software products to monitor the recharging demand of a fleet of electric conveyances. While such fleet management can include a specific company or industry, in certain configurations, the described fleet management approach can be used to arrange for the recharging of each electric vehicle within a given area.

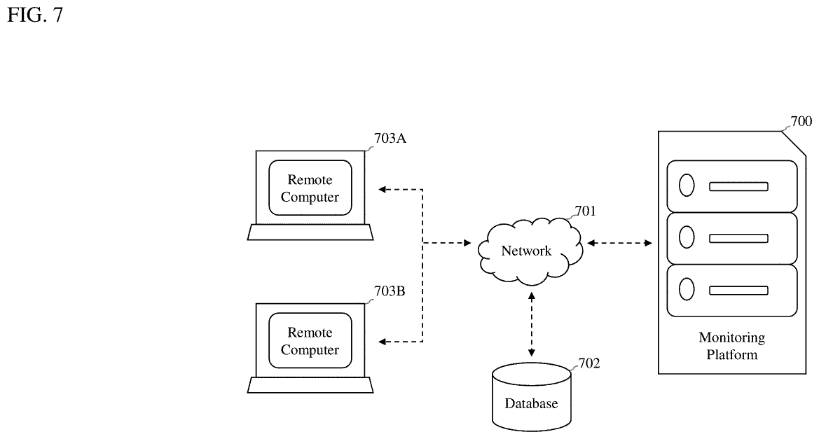

As shown in FIG. 7, such software can be implemented according to the system diagram. As shown, a monitoring platform 700, which includes one or more computers, is configured to communicate over a network 701 with one or more databases 702 and one or more remote computers 703A and 703B. In one or more configurations, the monitoring platform 700 is a server made up of multiple computers. In one particular implementation, the remote computer 703A is a computer operating in an electric vehicle or conveyance and configured to communicate with the monitoring platform 700 over a network 701 such as the Internet. In a further configuration, the remote computer 703B is a computer configured to monitor one or more energy storage charging facilities or electric vehicle charging stations.

In one approach, the recharging coordination and management software includes a processor configured, by one or more modules to access, receive or query from a database, conveyance data from a plurality of electrically powered conveyances. In one arrangement, the conveyance data includes, for each of the plurality of electrically powered conveyances, a value corresponding to an energy usage rate, a recharging load value, the effective range of the electrically powered conveyance as a function of energy usage, and a location of the electrically powered conveyance.

The processor is also configured to receive or access (for example, either directly or from a suitably current database 702) facility data from a plurality of energy production facilities, the facility data including a location of the facility, a capacity state of the facility, and a capacity of the facility. In one or more configurations, the capacity state data of the facility data includes at least one of a present capacity state of the facility and a future capacity state of the facility.

Using this data, the processor or computer 700 is configured to determine a recharging location for each of the plurality of electrically powered conveyances that is within the effective range of each respective one of the plurality of electrically powered conveyances. In a further implementation, the computer 700 is configured to dispatch each of the plurality of electrically powered conveyances to a location to receive recharging, wherein the recharging location is determined based on at least the effective range of each of the plurality of electrically powered conveyances and the demand state of the recharging location.

In a further configuration, the processor or computer 700 is configured to send an instruction to one or more of the plurality of electrically powered conveyances to change the energy usage rate. The monitoring platform 700 receives updated conveyance data that includes an updated effective range of at least one of the plurality of electrically powered conveyances. The monitoring platform 700 is further configured to update the recharging location assigned to each of the one or more of the plurality of electrically powered conveyances in response to sending the instruction.

In yet a further configuration, the monitoring platform 700 is configured by one or more modules to send a portion of the conveyance data to the one or more energy storage charging facilities or electric vehicle charging stations (such as facility remote computer 703B), wherein the portion of the conveyance data includes the recharging load value. The monitoring platform 700 is further configured to receive an updated future capacity state of a respective one of the facilities and determine an updated recharging location for an unassigned electrically powered conveyance. Furthermore, the monitoring platform 700 is also configured by one or more software modules to send an updated recharging location assigned to each of the one or more of the plurality of electrically powered conveyances in response to receiving at least an updated future capacity state.

It will be further appreciated that computers, processors or computing devices described herein can communicate with the one or more remote networks using USB, digital input/output pins, eSATA, parallel ports, serial ports, FireWire, Wi-Fi, Bluetooth, or other communication interfaces. In a particular configuration, computing devices, processors or computers provided herein may be further configurable through hardware and software modules so as to connect to one or more remote servers, computers, peripherals or other hardware using standard or custom communication protocols and settings (e.g., TCP/IP), either through a local or remote network or through the Internet. Computing devices, processors or computers provided herein may utilize wired or wireless communication means, such as, but not limited to CDMA, GSM, Ethernet, Wi-Fi, Bluetooth, USB, serial communication protocols and hardware to connect to one or more access points, exchanges, network nodes or network routers.

It should be further appreciated that, with respect to each and every component of the systems, methods and apparatus described herein, each component may be separated into more elements, or two or more components may be combined together into a single element. Moreover, each component may be replicated to support the execution of the corresponding operations in parallel. Moreover, unless specified otherwise, any interaction between different components generally does not need to be continuous, and it may be either direct or indirect through one or more intermediaries.

One aspect of the present disclosure includes a system, method, and/or computer program product configured to implement the functionality provided in this disclosure and the associated Drawings. In implementations utilizing a computer program, the computer program may include a computer readable storage medium (or media) having computer readable program instructions thereon for causing a processor to carry out aspects of the disclosure provided herein. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, including but not limited to, the Internet, a local area network (LAN), a wide area network (WAN) and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations to implement any functionality described herein may be encoded in assembler instructions, instruction-set-architecture (ISA) instructions, machine instructions, machine dependent instructions, microcode, firmware instructions, state-setting data, or either source code or object code written in any combination of one or more standard, custom, proprietary or modified programming languages such as a standard set, subset, superset or extended set of JavaScript, PHP, Ruby, Scala, Erlang, C, C++, Objective C, Swift, C #, Java, Assembly, Go, Python, Perl, R, Visual Basic, Lisp, Julia, or any other object oriented, functional or other paradigm based programming language.

The computer readable program instructions may execute entirely on the user's computer, partly on the user's computer, as a stand-alone software package, partly on the user's computer and partly on the remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present disclosure are described herein with reference to flowchart illustrations and/or block diagrams of methods, apparatus (systems), and computer program products according to a non-limiting set of implementations. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via a processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable data processing apparatus, or other device to produce a computer implemented process, such that the instructions which execute on the computer, other programmable data processing apparatus, or other device implement the functions/acts specified in the flowchart and/or block diagram block or blocks. The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

While this specification contains many specific embodiment details, these should not be construed as limitations on the scope of any embodiment or of what can be claimed, but rather as descriptions of features that can be specific to particular implementations of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the Drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components and/or groups thereof.

It should be noted that use of ordinal terms such as “first,” “second,” “third,” etc., in the claims to modify a claim element does not by itself connote any priority, precedence or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying Figures do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and reference were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

1. A power management system comprising:
an electric vehicle charging facility having an energy storage device integrated into the electric vehicle charging facility, the energy storage device configured to store energy, the energy storage device having an input to receive energy and an output to discharge energy;
a power management device configured to selectively receive energy from one of a plurality of energy sources or the energy storage device integrated into the electric vehicle charging facility and further configured to route received energy to a load coupled to the electric vehicle charging facility; and
a processor configured by one or more modules executing as code to:
receive a cost for energy available from one of the plurality of energy sources;
determine the cost of the energy stored in the energy storage device;
cause the power management device to select either one of the plurality of energy sources or the energy storage device to receive energy therefrom based on at least one of the received cost and the determined cost; and
cause the power management device to deliver the energy received from the selected energy source to the load coupled to the electric vehicle charging facility.

2. The system of claim 1, wherein the energy storage device is configured to store electrical energy and is removable from the electric vehicle charging facility.

3. The system of claim 1, wherein the power management device is further configured to direct energy from the plurality of energy sources to the energy storage device.

4. The system of claim 3, wherein the processor is further configured to:
determine a present energy storage level value of the energy storage device;
receive a cost value for energy provided by each one of the plurality of energy sources;
determine a lowest cost energy source by comparing each of the cost values received; and
cause the power management device to direct energy from the lowest cost energy source to the energy storage device, when the present energy storage level is below a predetermined threshold.

5. The system of claim 4, wherein the plurality of energy sources includes an electrical grid; renewable generation equipment including at least one of solar panels, wind turbines, geothermal wells, hydroelectric dams and wave energy converters; fueled generation equipment including at least one of reciprocating engines, gas turbines, steam turbines, microturbines and fuel cells; and electrically powered conveyances.

6. The system of claim 1, further comprising a point-of-sale system configured to provide an energy price value, the point-of-sale system configured to receive data from the processor in response to a signal representing a user demand for energy and the processor configured to:
determine a total energy demand from the user;
determine the capacity level of each of the plurality of energy sources;
predict, using one or more predictive algorithms, that the total energy demand from the user will change the cost of each of the plurality of energy sources based, at least, upon the capacity level for each of the plurality of energy sources;
determine the energy source that provides the lowest predicted energy cost for the total demand; and
cause the power management system to deliver the energy from the energy source that provides the lowest predicted energy cost to the load.

7. A computer implemented method comprising a computer configured to:
receive, for a plurality of energy demand locations consisting of electric vehicle charging facilities, energy demand data, wherein the energy demand data includes at least an energy demand value corresponding to the amount of energy needed by one or more potential purchasers of energy, a location value, and an energy demand price value;
compare the energy demand value to a predetermined demand threshold value and the energy demand price value to a predetermined price threshold value; and
cause one of a plurality of energy transport devices, each of the plurality of energy transport devices configured to transport at least one energy storage device, the energy storage device configured to discharge energy stored therein, to travel to at least one energy demand location consisting of an electric vehicle charging facility where the energy demand value is above a predetermined demand threshold value and the energy demand price value is above a predetermined price threshold value.

8. The method of claim 7, further comprising:
receiving, for a plurality of energy production facilities, energy production data, where the energy production data includes for each of the plurality of energy production facilities, an energy production capacity, an energy production cost value, and the availability of at least one of a plurality of energy transport devices associated with the energy production facility.

9. The method of claim 7, further comprising,
comparing the cost of the energy stored in each of the energy storage devices transported by at least one of the plurality of available energy transport devices;
calculating an energy transport cost value that represents the cost of transporting the energy storage device to the energy demand location consisting of an electric vehicle charging facility;
determining an effective cost value of the energy stored in each of the energy storage devices based on at least the energy production cost value and the energy transport cost value;
calculating an energy demand price threshold value based on the effective cost values of each of the energy storage devices; and
identifying at least one of the plurality of available energy transport devices that is transporting at least one energy storage device that contains energy stored with an effective cost that is less than or equal to the energy demand price threshold value.

10. The method of claim 7, further comprising:
determining the energy level value of at least one of the energy storage devices transported by at least one of the plurality of energy transport devices;
identifying, from the energy demand data, one of the plurality of energy demand locations consisting of electric vehicle charging facilities that have an energy demand value below a predetermined demand threshold value, and are within a distance threshold of the one of the plurality of energy transport devices; and
instructing the one of the plurality of energy transport devices to travel to the identified energy demand location consisting of an electric vehicle charging facility for which the transported energy storage device has sufficient energy to meet the predetermined demand threshold value.

11. The method of claim 7, wherein the energy transport device is an autonomous vehicle configured to communicate with at least one remote computer providing destination data.

12. The method of claim 7, wherein at least one of the plurality of energy transport devices include one or more removable energy storage devices.

13. The method of claim 7, further comprising:
delivering at least one energy storage device transported by at least one of the plurality of energy transport devices to the energy demand location consisting of an electric vehicle charging facility.

14. The method of claim 7, wherein the energy storage devices are configured to discharge electrical energy.

15. The method of claim 7, wherein the energy demand location consisting of an electric vehicle charging facility is configured to receive electrical energy from the energy storage devices.

16. A method of monitoring electric conveyance recharging demand, comprising:
receiving, by a processor configured by one or more modules, conveyance data from a plurality of electrically powered conveyances, the conveyance data including for each of the plurality of electrically powered conveyances: an energy level value, an energy usage rate value, a recharging load value, an effective range as a function of energy usage rate value, and a location value;
accessing, by the processor, facility data from a plurality of energy demand locations consisting of electric vehicle charging facilities, the facility data including, for each energy demand location: a location of the energy demand location and a capacity state of the energy demand location;
determining, by the processor, an energy demand location consisting of an electric vehicle charging facility for each of the plurality of electrically powered conveyances to receive recharging that is within the effective range of each respective one of the plurality of electrically powered conveyances; and
dispatching, by the processor, to each of the plurality of electrically powered conveyances, an energy demand location consisting of an electric vehicle charging facility to receive recharging, wherein the energy demand location provided to each of the plurality of electrically powered conveyances is determined based on at least the effective range of each of the plurality of electrically powered conveyances and the capacity state of the energy demand location.

17. The method of claim 16, further comprising:
sending, by the processor, an instruction to one or more of the plurality of electrically powered conveyances to change the energy usage rate;
receiving, by the processor, updated conveyance data that includes an updated effective range of at least one of the plurality of electrically powered conveyances; and
updating, the energy demand location consisting of an electric vehicle charging facility assigned to each of the one or more of the plurality of electrically powered conveyances to receive recharging in response to sending the instruction.

18. The method of claim 16, wherein the capacity state of the facility data for each energy demand location consisting of an electric vehicle charging facility includes at least one of a present capacity state of the facility and a future capacity state of the facility.

19. The method of claim 18, further comprising:
sending, by the processor, a portion of the conveyance data to the one or more energy demand locations consisting of electric vehicle charging facilities, wherein the portion of the conveyance data includes the recharging load value;
receiving, by the processor, an updated future capacity state of a respective one of the energy demand locations consisting of electric vehicle charging facilities;
determining, by the processor, an updated energy demand location consisting of an electric vehicle charging facility for an unassigned electrically powered conveyance to receive recharging; and
sending, by the processor, an updated energy demand location consisting of an electric vehicle charging facility assigned to each of the one or more of the plurality of electrically powered conveyances to receive recharging in response to receiving at least an updated future capacity state.
